(19) United States
(12) Patent Application Publication
(10) Pub. No.: US 2005/0138664 A1
(43) Pub. Date: Jun. 23, 2005

(54) System and method for allocating resources in an adaptive media center processing system

(76) Inventor: Raja Neogi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,461

(22) Filed: Dec. 23, 2003

(51) Int. Cl. H04N 7/173; H04N 7/18

(52) U.S. Cl. 725/80; 725/81; 725/89; 725/94; 725/90

(57) ABSTRACT

A system and method for allocating resources in an adaptive media processing system. The method involves receiving a request to reserve a spatial resource for an application. Then, it is determined whether the spatial resource is available for the application and whether morphing of the spatial resource is required. The spatial resource is then reserved for the application if the spatial resource is available for the application.

### BACKGROUND

The media center processing systems of today are designed to allow multiple heterogeneous applications to co-exist. Such applications include, but are not limited to, a personal video recorder (PVR), a digital video disk (DVD) recorder, a compact disk (CD) remote photo viewing, Electronic Program Guide (EPG), picture in picture (PIP), and so forth. The resource requirements for these applications do not necessarily scale linearly. In addition, there can be variations in processing of the applications, both parameter wise and specification wise.

The co-existence of the applications in the media center processing system is constrained by the availablity of underlying resources within the system. In general, two types of resources exist in the media center processing system, including spatial and temporal resources. Spatial resources (e.g., a tuner) are allocated for the lifetime of the application, whereas temporal resources (e.g., serial peripheral interface (SPI)) need to be time-shared. Temporal resources are needed to program the spatial resources.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for allocating resources to applications in an adaptive media processing system, in which some embodiments of the present invention may operate;

FIG. 2 illustrates a four layer model of the media center system, according to an embodiment of the invention;

FIG. 3 illustrates the interaction between the user interface layer, the application layer, the virtual machine layer and the hardware and operating system layer as it relates to a specific client request, according to an embodiment of the invention;

FIG. 4 is a flow diagram of one embodiment of a process for resource allocation between the application layer and the virtual machine layer; and

FIG. 5 is a flow diagram of one embodiment of a process for the resource negotiation or allocation between the application layer and the virtual machine layer.

### DESCRIPTION OF THE EMBODIMENTS

A system and method for allocating resources in an adaptive media processing system are described. In the following description, for purposes of explanation, numerous specific details are set forth. It will be apparent, however, to one skilled in the art that embodiments of the invention can be practiced without these specific details.

Embodiments of the present invention may be implemented in software, firmware, hardware, or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and hardware components.

Thus, a machine-readable medium may include any mechanism for storing or transmitting information in a form readable by a machine (e.g., a computer). These mechanisms include, but are not limited to, floppy diskettes, optical disks, Compact Disc Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

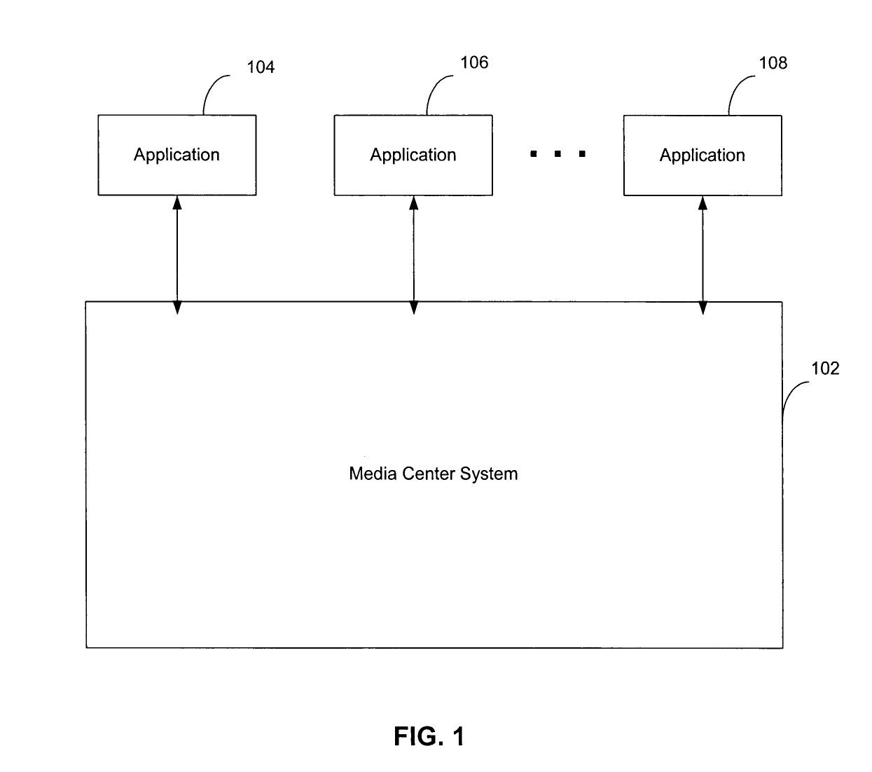

FIG. 1 illustrates one embodiment of an environment for allocating resources to applications in an adaptive media processing system, in which some embodiments of the present invention may operate. The specific components shown in FIG. 1 represent one example of a configuration that may be suitable for the invention and is not meant to limit the invention.

Referring to FIG. 1, the environment for allocating resources to applications in an adaptive media processing system includes, but is not necessarily limited to, a media center system 102 and one or more applications 104, 106 and 108. Though only three applications are shown in FIG. 1, it is understood that one, two, three or more applications may be present in the environment.

Applications 104, 106 and 108 are registered with media center system 102. In an embodiment not meant to limit the invention, media center system 102 and applications 104, 106 and 108 may be networked together via an 802.11 wireless network. Other networks may be added or substituted for the 802.11 wireless network according to the particular application for the environment in FIG. 1 and as new types of networks are developed.

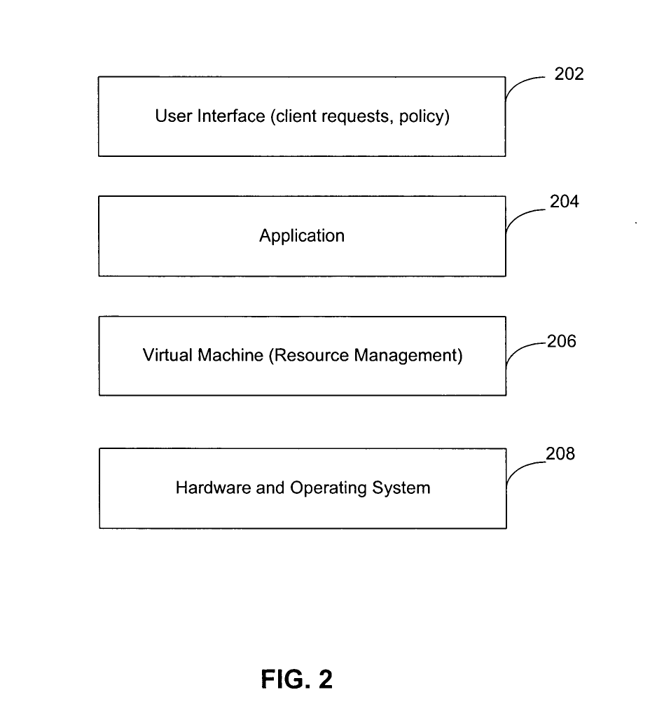

At a high level, applications 104, 106 and 108 request that they be admitted into media center system 102. In order for media center system 102 to admit any application, media center system 102 must be able to reserve the necessary resources for that application. The necessary resources may include both spatial and temporal resources. Spatial resources (e.g., a tuner) are allocated for the lifetime of the application, whereas temporal resources (e.g., serial peripheral interface (SPI)) need to be time-shared. Temporal resources are needed to program the spatial resources. Both spatial and temporal resources are described below in more detail with reference to FIG. 2. Each of media center system 102 and applications 104, 106 and 108 of FIG. 1 is described in more detail next.

The convergence of the television receiver and the personal computer has accelerated with the advent of media center or set-top computer systems. By combining the capabilities of a computer system and a television, media center system 102 may provide the user advanced television programming features.

Media center system 102 accepts one or more media streams as input. The inputs may include, but are not limited to, media streams from applications 104, 106 and 108. Other inputs may be added or substituted for those described as new inputs are developed and according to the particular application for media center system 102. These inputs, after processing, selection and control (by media center system 102), may be used to generate different outputs for a user.

The different outputs described above may be received by, but are not necessarily limited to, applications 104, 106 and 108, a display, a memory card, and so forth. Other outputs may be added or substituted for those described as new outputs are developed and according to the particular application for media center system 102. The audio portion of the output may be routed through an amplifier, such as an A/V receiver or a sound processing engine, to headphones, speakers or any other type of sound generation device.

Media center system 102 may also provide connectivity to external devices through, for example, a telephone port, a network port or an infrared port. The user interface is provided through, for example, a keyboard or remote controls. These examples are not meant to limit the invention.

Media center system 102 as described in FIG. 1 is able to support communication through wide area network (WAN) and local area network (LAN) connections, Bluetooth, Institute of Electrical and Electronics Engineers (IEEE) 802.11 , universal serial bus (USB), 1394, intelligent drive electronics (IDE), peripheral component interconnect (PCI) and infrared. Other interfaces may be added or substituted for those described as new interfaces are developed and according to the particular application for media center system 102.

There are many different equipment configurations for media center system 102 of FIG. 1 and many different possible choices of equipment to connect. It is to be appreciated that a lesser or more equipped media center system 102 than the example described above may be preferred for certain implementations. Therefore, the configuration of media center system 102 will vary from implementation to implementation depending upon numerous factors, such as price constraints, performance requirements, technological improvements, or other circumstances.

Applications 104, 106 and 108 may include, but are not limited to, a PVR, a DVD recorder, a CD, remote photo viewing, EPG, PIP, and so forth. Other types of applications may be added or substituted for those described as new types of applications are developed.

FIG. 2 illustrates a four layer model of a media center system, according to an embodiment of the invention. Referring to FIG. 2, the four layers include a user interface (UI) layer 202, an application layer 204, a virtual machine layer 206 and a hardware and operating system layer 208. Resource allocation occurs between application layer 204 and virtual machine layer 206. Each of these layers is briefly described next.

UI layer 202 is reserved for policy injection. UI layer 202 also listens to client requests and brokers the distribution of these client requests to application layer 204. Application layer 204 manages the application state and flow-graph, but is largely unaware of the status of the resources in the network.

Virtual machine layer 206 handles resource management and component parameterization. Virtual machine layer 206 is resource aware and includes a resource manager. All requests and negotiations are directed to virtual machine layer 206. This layer also brokers the parameterization of computation elements.

The resource manager of virtual machine layer 206 monitors spatial and temporal resources in the system, processes requests from clients, allocates the spatial and temporal resources, manages the related states of the spatial and temporal resources, and so forth. Spatial resources (e.g., tuner, transport, security, time shifter, codec, graphics, display, etc.) are allocated for the lifetime of the application, whereas temporal resources (e.g., interfaces such as universal asynchronous receiver transmitter (UART), Inter-IC (I2C), SPI, general purpose input/output (GPIO), etc.) need to be time-shared. In an embodiment of the invention, both temporal and spatial resources may be re-parameterized (e.g. fast forward) and optionally morphed (e.g., load windows media codec) at the base of each resource access. Temporal resources are needed to program the spatial resources. In general, temporal resources are not visible to application layer 204 and hide behind the spatial resources. In an embodiment of the invention, for each spatial resource there exists a temporal resource tree listing the status of passive interfaces that allow the programming of spatial resources.

In an embodiment of the invention, temporal resources are modeled in two ways. The more common way to model temporal resources includes via various passive interfaces, like UART, I2C, SPI, GPIO, video front-end, and so forth. Here, the resource manager of virtual machine layer 206 locks these passive interfaces while in use by a spatial resource. In an embodiment of the invention, for each spatial resource there exists a temporal resource tree listing the status of passive interfaces that allow the programming of that spatial resource. For example, the SPI may be used to program a MPEG encoder in an analog tuner.

The second way to model temporal resources arises when the application pipeline is deeper than the physical pipeline. Here, control code is morphed (assuming control switching is supported by underlying processors) and the context stored in separate buffers for co-existence. A morphing frequency is calculated at the time of resource allocation to ensure there is margin for control, context and configuration switching without violating any real-time deadlines. For example, in an embodiment, the integrated latency bound cannot exceed 33 ms.

Hardware and operating system layer 208 includes, but is not limited to, the node operating system and the physical spatial and temporal hardware resources. These physical spatial and temporal hardware resources may include one or more of the following: a tuner, a transport, a security, a time shifter, a codec, graphics, a display, a driver, memory, a register, a peripheral, an on-chip hardware-accelerator, communication bandwidth, an interface, an array of processors, custom data/control structures, and so forth. In an embodiment of the invention, these spatial and temporal hardware resources may reside in shared or distributed multi-port random access memories (RAMS) or local registers. Other hardware resources may be added or substituted for those described as new hardware resources are developed and according to the particular application for media center system 102.

In an embodiment of the invention, the layers shown in FIG. 2 may be distributed across a system area network, as long as such distribution expands the allocation decision space. For example, separating the address space of UI layer 202 and application layer 204 could limit the allocation space. This limitation of the allocation space may be due to a high communication bandwidth requirement.

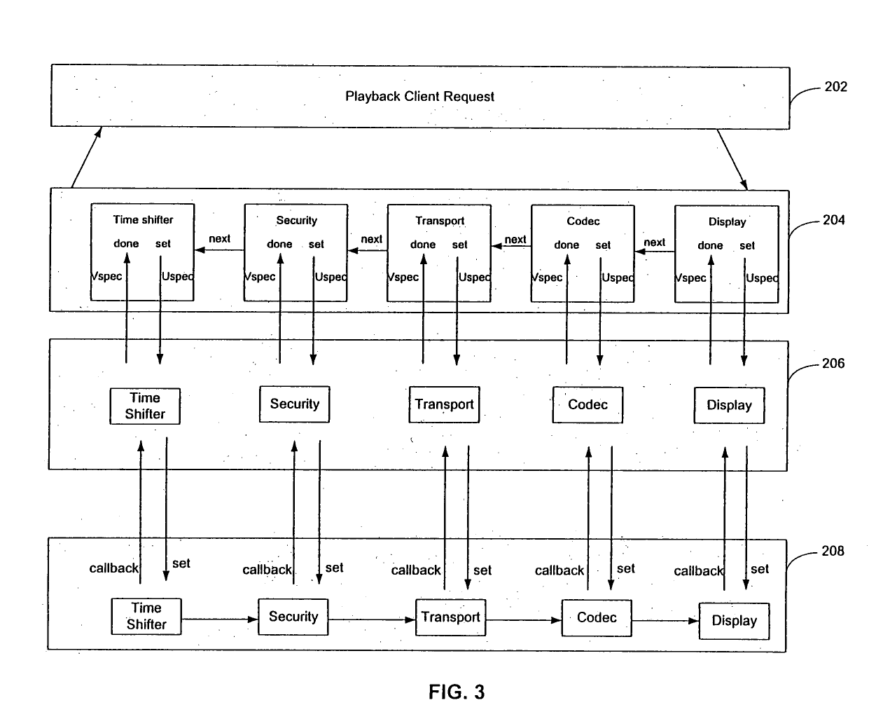

The interaction between UI layer 202, application layer 204, virtual machine layer 206 and hardware and operating system layer 208 as it relates to a specific client request is described in more detail next with reference to FIG. 3. The specific client request described in FIG. 3 is not meant to limit the invention and is provided for illustration purposes only.

In FIG. 3, assume that the application is a PVR and the client request involves a PVR playback client request. As described above, UI layer 202 listens to client requests and brokers the distribution of these client requests to application layer 204.

Application layer 204 manages the application state and flow-graph, but is largely unaware of the status of the resources in the network. Application layer 204 segments the application loop into a set of computation elements based on resource needs in hardware and operating system layer 208 for the PVR playback client request. For example, assume that application layer 204 determines that the PVR playback client request requires the services of the following spatial resources (or computation elements): a time shifter, a security, a transport, a codec and a display. Application layer 204 negotiates with virtual machine layer 206 for each type of these spatial resources. This negotiation involves, for each of the spatial resources, a parameter range called a Uspec being sent from application layer 204 to virtual machine layer 206 and a Vspec being sent from the virtual machine layer 206 to application layer 204. The Uspec includes a parameter range for the spatial resource that is acceptable to the application, and also optionally includes an index to morph-able machine code or executables (i.e., pre-compiled library component) mimicking algorithm variations. The Vspec includes a parameter range for the spatial resource that is reserved for or granted to the application by virtual machine layer 206. This negotiation between application layer 204 and virtual machine layer 206 continues until all of the spatial resources have been negotiated.

Virtual machine layer 206 handles resource management and component parameterization. Virtual machine layer 206 is resource aware and includes a resource manager. All requests and negotiations are directed to virtual machine layer 206. This layer also brokers the parameterization of computation elements. As described above, virtual machine layer 206 sends back to application layer 204 a Vspec for each negotiated resource, where the Vspec indicates the allowable parameter range for the negotiated resource.

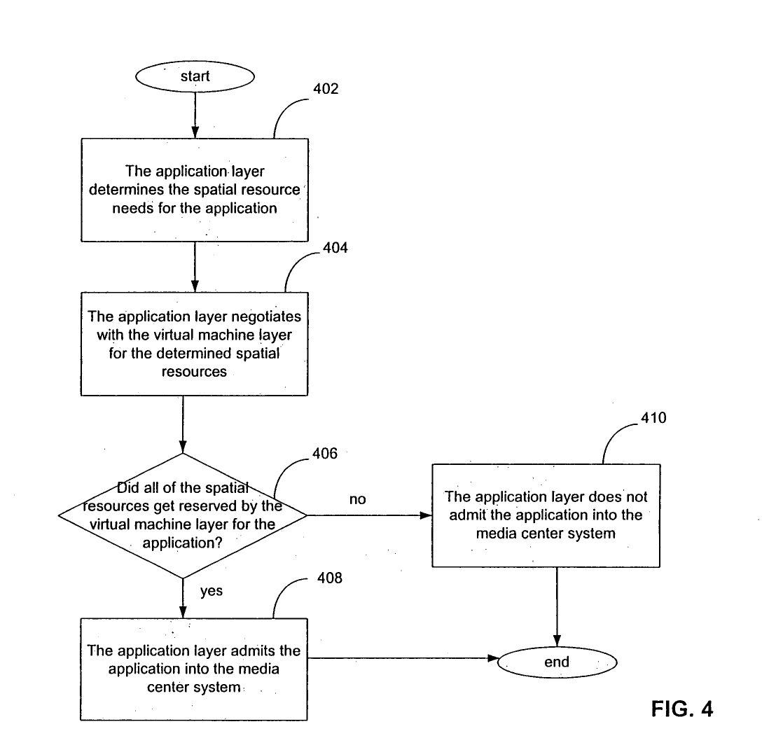

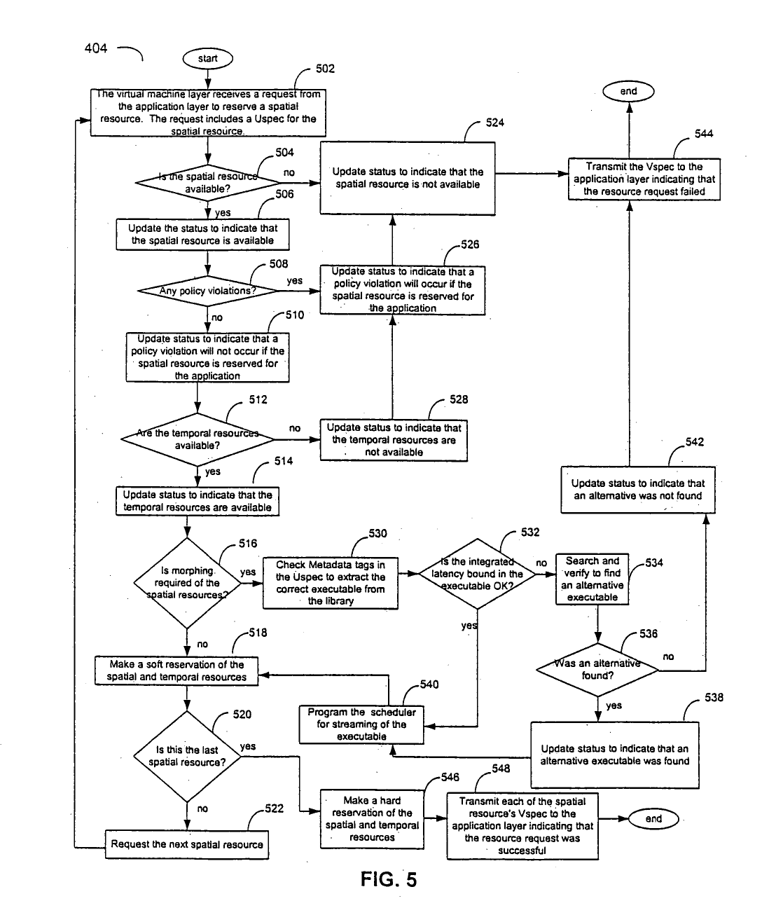

For example, as shown in FIG. 3, application layer 204 first sends the Uspec for the display spatial resource to virtual machine layer 206. Virtual machine layer 206 determines whether the display spatial resource can be reserved for the application and, if so, sends a Vspec back to application layer 204. Here, the Vspec indicates a soft reservation for the display spatial resource. If the application layer 204 receives the Vspec for the display spatial resource back from virtual machine layer 206, it then uses this Vspec to create the Uspec for the next spatial resource it needs (i.e., the codec spatial resource). This process continues until virtual machine layer 206 sends a Vspec for the last spatial resource requested by application layer 204 (i.e., time shifter). In an embodiment of the invention, a hard reservation for the requested spatial resources will only happen once it is determined that all of the requested spatial resources can be reserved for the application. If virtual machine layer 206 determines, at any point along the request for the spatial resources, that a requested spatial resource cannot be reserved for the application, then application layer 204 receives notice of this and any previous soft reservations are cancelled or reset. An embodiment of the resource allocation between application layer 204 and virtual machine layer 206 is described in more detail below with reference to FIGS. 4 and 5.

A hard reservation for the requested spatial resources will only happen once it is determined that all of the requested spatial resources can be reserved for the application. This hard reservation occurs between virtual machine layer 206 and hardware and operating system layer 208.

Referring to the example in FIG. 3, virtual machine layer 206 first sends a set instruction to hardware and operating system layer 208 in order to make a hard reservation for the time shifter spatial resource. Once the hard reservation is made for the time shifter spatial resource, hardware and operating system layer 208 sends a callback instruction to virtual machine layer 206. Next, virtual machine layer 206 sends a set instruction to hardware and operating system layer 208 in order to make a hard reservation for the security spatial resource. Once the hard reservation is made for the security spatial resource, hardware and operating system layer 208 sends a callback instruction to virtual machine layer 206. This continues until all of the spatial resources are hard reserved.

An embodiment of the resource allocation between application layer 204 and virtual machine layer 206 is described next with reference to FIGS. 4 and 5. FIG. 4 is a flow diagram of one embodiment of a process for resource allocation between application layer 204 and virtual machine layer 206. Referring to FIG. 4, the process begins at processing block 402. Here, application layer 204 determines the spatial resource needs for the application.

At processing block 404, application layer 204 negotiates with virtual machine layer 206 for the determined spatial resources. In an embodiment of the invention, application layer 204 sends a sequence of temporally separated Uspecs (one for each of the determined spatial resources) to virtual machine layer 206. Also in an embodiment of the invention, virtual machine layer 206 queues up the Uspecs (or spatial resource requests) in a first-in-first-out (FIFO) queue. For each spatial resource reserved by virtual machine layer 206 for the application, virtual machine layer 206 sends to application layer 204 a corresponding Vspec. Processing block 404 is described in more detail with reference to FIG. 5 below.

At decision block 406, it is determined whether all of the requested spatial resources were reserved by virtual machine layer 406 for the application. If so, then at processing block 408, application layer 204 admits the application into media center system 102. If not, then at processing block 410, application layer 204 does not admit the application into media center system 102. The process of FIG. 4 ends at this point.

FIG. 5 is a flow diagram of one embodiment of a process for the resource negotiation or allocation between application layer 204 and virtual machine layer 206 (processing block 404 of FIG. 4). Referring to FIG. 5, the process begins at processing block 502. Here, virtual machine layer 206 receives a request from application layer 204 to reserve a spatial resource. The request includes a Uspec for the spatial resource. As described above, the Uspec includes a parameter range for the spatial resource that is acceptable to the application, and also optionally includes an index to morph-able machine code or executables (i.e., pre-compiled library component) mimicking algorithm variations.

At decision block 504, it is determined whether the spatial resource requested by application layer 204 is available. This is determined by virtual machine layer 206. If not, then the process continues at processing block 524 where the status is updated by virtual machine layer 206 to indicate that the spatial resource is not available. In an embodiment, the status is updated by saving soft updates (i.e., saving context) to a traceability database. The process continues at processing block 544 where virtual machine layer 206 transmits the Vspec of the requested resource to application layer 204 indicating that the resource request failed. The process in FIG. 5 ends at this point.

If at decision block 504 it is determined that the spatial resource requested by application layer 204 is available, then the process continues at processing block 506 where the status is updated by virtual machine layer 206 to indicate that the spatial resource is available. In an embodiment, the status is updated by saving soft updates to the traceability database.

At decision block 508, it is determined whether any policy violation will occur if the requested spatial resource is reserved for the application. An example of a possible policy violation would be to allocate the last tuner in media center system 102 to PIP. If so, then the process continues at processing block 526 where the status is updated to indicate that a policy violation will occur if the spatial resource is reserved for the application. In an embodiment, the status is updated by saving soft updates to the traceability database. From processing block 526, the process proceeds to processing blocks 524 and 544 (described above) and the process in FIG. 5 ends at this point.

If at decision block 508, it is determined that a policy violation will not occur if the request spatial resource is reserved for the application, then the process continues at processing block 510. Here, the status is updated to indicate that a policy violation will not occur if the spatial resource is reserved for the application. In an embodiment, the status is updated by saving soft updates to the traceability database.

At decision block 512, it is determined whether the necessary temporal resources for the spatial resource are available. As described above, temporal resources are needed to program the spatial resources. If not, then the process continues at processing block 528 where the status is updated to indicate that the temporal resources are not available. In an embodiment, the status is updated by saving soft updates to the traceability database. From processing block 528, the process proceeds to processing blocks 526, 524 and 544 (described above) and the process in FIG. 5 ends at this point.

If at decision block 512, it is determined that the necessary temporal resources for the spatial resource are available, then the process continues at processing block 514. Here, the status is updated to indicate that the temporal resources are available. In an embodiment, the status is updated by saving soft updates to the traceability database.

At decision block 516, it is determined whether morphing is required of the spatial resources. If so, then the process continues at processing block 530. Here, metadata tags in the Uspec are checked in order to extract the correct executable from a library. As described above, the Uspec includes a parameter range for the spatial resource that is acceptable to the application, and also optionally includes an index to morph-able machine code or executables (i.e., pre-compiled library component) mimicking algorithm variations.

At decision block 532, the integrated latency bound in the extracted executable is checked. As described above, the morphing frequency is calculated at the time of resource allocation to ensure there is margin for control, context and configuration switching without violating any real-time deadlines. For example, in an embodiment, the integrated latency bound cannot exceed 33 ms. If at decision block 532 it is determined that the latency bound is not OK, then the process continues at processing block 534.

In processing block 534, virtual machine layer 206 searches for and verifies an alternative executable other than the executable indicated by the Uspec. Here, virtual machine layer 206, based on current conditions in media center system 102, may be able to locate an executable that will better fit these current conditions.

At decision block 536, it is determined whether an alternative executable was found. If not, then the process continues at processing block 542 where the status is updated to indicate that an alternative executable was not found. In an embodiment, the status is updated by saving soft updates to the traceability database. From processing block 542, the process continues to processing block 544 (described above) and the process in FIG. 5 ends at this point.

If at decision block 536 it was determined that an alternative executable was found, then the process continues at processing block 538 where the status is updated to indicate that an alternative executable was located. In an embodiment, the status is updated by saving soft updates to the traceability database. The process continues at processing block 540 (described below).

If at decision block 532, it is determined that the integrated latency bound in the extracted executable is OK, then the process continues at processing block 540. At processing block 540, a scheduler is programmed for streaming of the executable. The process continues at processing block 518 (described below).

If at decision block 516, it is determined that morphing is not required of the spatial resources, then the process continues at processing block 518. At processing block 518, a soft reservation is made of the spatial resource and its temporal resources.

At decision block 520, it is determined whether the spatial resource was the last spatial resource requested by the application. If not, then the process goes back to processing block 502 to retrieve the next spatial resource request from application layer 204. Otherwise, the process continues at processing block 546.

At processing block 546, a hard reservation is made for the spatial and temporal resources. In an embodiment of the invention, a hard reservation for the requested spatial resources will only happen once it is determined that all of the requested spatial resources can be reserved for the application.

At processing block 548, virtual machine layer 206 transmits the Vspec for each reserved spatial resource to application layer 204 indicating that the resource request was successful. The Vspec includes a parameter range for the spatial resource that is being reserved for the application. The process in FIG. 5 ends at this point.

A system and method for allocating resources in an adaptive media processing system have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
receiving a request to reserve a spatial resource for an application;
determining whether the spatial resource is available for the application;
morphing the spatial resource if required; and
reserving the spatial resource for the application if the spatial resource is available for the application.

2. The method of claim 1, wherein the request to reserve a spatial resource includes a first parameter range for the spatial resource, and wherein the first parameter range indicates desired parameters for the spatial resource.

3. The method of claim 2, wherein the first parameter range is a Uspec, wherein the Uspec indicates a metadata tag, wherein the metadata tag is used to locate an executable.

4. The method of claim 3, wherein morphing the spatial resource comprises:
determining whether an integrated latency bound of the executable is acceptable; and
if the integerated latency bound of the executable is not acceptable, then locating an alternative executable.

5. The method of claim 1, further comprising:
sending an indication that the spatial resource has been reserved for the application, wherein the indication includes a granted paramter range, and wherein the granted paramter range indicates parameters granted for the spatial resource.

6. The method of claim 1, further comprising:
determining whether additional spatial resources need to be reserved for the application, and if so, then reserving the spatial resource only if the spatial resource and the additional spatial resources are available for the application.

7. The method of claim 1, wherein determining whether the spatial resource is available for the application includes determining whether one or more temporal resources required to program the spatial resource are available.

8. A system comprising:
an application layer; and
a virtual machine layer, wherein the virtual machine layer receives a request to reserve a spatial resource for an application from the application layer, wherein the virtual machine layer determines whether the spatial resource is available for the application, wherein the virtual machine layer morphes the spatial resource if required, and wherein the virtual machine layer reserves the spatial resource for the application if the spatial resource is available for the application.

9. The system of claim 8, wherein the request to reserve a spatial resource includes a first paramter range for the spatial resource, and wherein the first paramter range indicates desired parameters for the spatial resource.

10. The system of claim 9, wherein the first paramter range is a Uspec, wherein the Uspec indicates a metadata tag, and wherein the metadata tag is used to locate an executable.

11. The system of claim 10, wherein the virtual machine layer morphes the spatial resource by determining whether an integrated latency bound of the executable is acceptable, and if the integerated latency bound of the executable is not acceptable, then the virtual machine layer locates an alternative executable.

12. The system of claim 8, wherein the virtual machine layer sends an indication that the spatial resource has been reserved for the application to the application layer, wherein the indication includes a granted parameter range, and wherein the granted paramter range indicates parameters granted for the spatial resource.

13. The system of claim 8, wherein the virtual machine layer determines whether additional spatial resources need to be reserved for the application, and if so, then the virtual machine layer reserves the spatial resource only if the spatial resource and the additional spatial resources are available for the application.

14. The system of claim 8, wherein the virtual machine layer determines whether the spatial resource is available for the application by determining whether one or more temporal resources required to program the spatial resource are available.

15. A machine-readable medium containing instructions which, when executed by a processing system, cause the processing system to perform a method, the method comprising:
receiving a request to reserve a spatial resource for an application;
determining whether the spatial resource is available for the application;
morphing the spatial resource if required; and
reserving the spatial resource for the application if the spatial resource is available for the application.

16. The machine-readable medium of claim 15, wherein the request to reserve a spatial resource includes a first paramter range for the spatial resource, and wherein the first paramter range indicates desired parameters for the spatial resource.

17. The machine-readable medium of claim 16, wherein the first paramter range is a Uspec, wherein the Uspec indicates a metadata tag, and wherein the metadata tag is used to locate an executable.

18. The machine-readable medium of claim 17, wherein morphing the spatial resource comprises:
determining whether an integrated latency bound of the executable is acceptable; and
if the integerated latency bound of the executable is not acceptable, then locating an alternative executable.

19. The machine-readable medium of claim 15, further comprising:
sending an indication that the spatial resource has been reserved for the application, wherein the indication includes a granted paramter range, and wherein the granted paramter range indicates parameters granted for the spatial resource.

20. The machine-readable medium of claim 15, further comprising:
determining whether additional spatial resources need to be reserved for the application, and if so, then reserving the spatial resource only if the spatial resource and the additional spatial resources are available for the application.

21. The machine-readable medium of claim 15, wherein determining whether the spatial resource is available for the application includes determining whether one or more temporal resources required to program the spatial resource are available.
